(19) United States
(12) Patent Application Publication
(10) Pub. No.: US 2026/0253173 A1
(43) Pub. Date: Aug. 27, 2026

(54) ELECTRONIC DEVICE FOR PERFORMING CONVOLUTION OPERATION AND OPERATING METHOD OF ELECTRONIC DEVICE

(71) Applicant: Samsung Electronics Co., Ltd., Suwon-si (KR)

(72) Inventors: Sunbum HAN, Suwon-si (KR); Daesung Lim, Suwon-si (KR)

(73) Assignee: Samsung Electronics Co., Ltd., Suwon-si (KR)

(21) Appl. No.: 19/650,751

(22) Filed: Apr. 17, 2026

Related U.S. Application Data
(63) Continuation of application No. PCT/KR2024/013236, filed on Sep. 3, 2024.

(30) Foreign Application Priority Data
Oct. 17, 2023 (KR) 10-2023-0138855

(51) Int. Cl. G06T 5/20; G06N 3/0464; G06T 3/40; G06T 7/11

(52) U.S. Cl. CPC G06T 5/20; G06N 3/0464; G06T 3/40; G06T 7/11

(57) ABSTRACT

An electronic device includes memory storing at least one instruction, a first filter memory storing a first convolution filter used for a convolution operation in a current frame, a second filter memory storing a second convolution filter used for a convolution operation in a next frame, and at least one processor. The least one instruction, when executed by the at least one processor individually or collectively, causes the electronic device to obtain the first convolution filter from the first filter memory in the current frame, perform a convolution operation by using the first convolution filter with respect to an input image, obtain a second convolution filter from the second filter memory in the next frame, and perform the convolution operation by using the second convolution filter with respect to the input image to obtain an output image.

### CROSS-REFERENCE TO RELATED APPLICATIONS

This application is a continuation of International Application No. PCT/KR2024/013236, filed on September 3, 2024, which is based on and claims priority to Korean Patent Application No. 10-2023-0138855, filed on October 17, 2023, in the Korean Intellectual Property Office, the disclosures of which are incorporated by reference herein in their entireties.

### BACKGROUND

### Field

The present disclosure relates to an electronic device and an operating method of the electronic device, and more particularly, to an electronic device for performing a convolution operation and an operating method of the electronic device.

### Description of Related Art

Recently, with technological advancements, display devices that provide 8K resolution screens have been available. However, most content on the market is produced in 4K resolution, and thus a technology that uses artificial intelligence to improve picture quality has been used as a method of fully utilizing the 8K resolution screen of the display device.

Among the technologies that improve image quality using artificial intelligence, a technology has been used that generates and provides content with improved image quality by performing a convolution operation.

### SUMMARY

According to an aspect of the disclosure, an electronic device for performing a convolution operation, includes: memory storing at least one instruction; a first filter memory storing a first convolution filter used in the convolution operation in a current frame; a second filter memory storing a second convolution filter used in the convolution operation in a next frame; and at least one processor, comprising processing circuitry, wherein the least one instruction, when executed by the at least one processor individually or collectively, causes the electronic device to: in the current frame, obtain the first convolution filter from the first filter memory and perform the convolution operation on an input image by using the first convolution filter, and in the next frame, obtain the second convolution filter from the second filter memory and perform the convolution operation on the input image by using the second convolution filter to obtain an output image.

According to an aspect of the disclosure, a method of an electronic device for performing a convolution operation, includes: obtaining a first convolution filter used for the convolution operation in a current frame from a first filter memory; in the current frame, performing the convolution operation on an input image by using the first convolution filter; obtaining a second convolution filter used for the convolution operation in a next frame from a second filter memory; and in the next frame, performing the convolution operation on the input image by using the second convolution filter to obtain an output image.

According to an aspect of the disclosure, a non-transitory computer-readable medium has recorded thereon a program including instructions that are executed by at least one processor of an electronic device to perform a method including: obtaining a first convolution filter used for the convolution operation in a current frame from a first filter memory; in the current frame, performing the convolution operation on an input image by using the first convolution filter; obtaining a second convolution filter used for the convolution operation in a next frame from a second filter memory; and in the next frame, performing the convolution operation on the input image by using the second convolution filter to obtain an output image.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram for explaining an operation of an electronic device according to an embodiment of the present disclosure;

FIG. 2 is a diagram for explaining the configuration of an electronic device according to an embodiment of the present disclosure;

FIG. 3 is a diagram for explaining an operation of an electronic device according to an embodiment of the present disclosure;

FIG. 4 is a diagram for explaining an operation of performing a convolution operation by an electronic device according to an embodiment of the present disclosure;

FIG. 5 is a diagram illustrating a convolution operation module implemented in hardware according to an embodiment of the present disclosure;

FIG. 6 is a diagram for explaining an operation of obtaining a convolution filter from a memory by an electronic device according to an embodiment of the present disclosure;

FIG. 7 is a diagram for explaining the configuration of a first filter memory according to an embodiment of the present disclosure;

FIG. 8 is a diagram for explaining the configuration of a first filter memory according to an embodiment of the present disclosure;

FIG. 9 is a diagram for explaining the configuration of a first filter memory according to an embodiment of the present disclosure;

FIG. 10 is a diagram for explaining the configuration of a first filter memory according to an embodiment of the present disclosure;

FIG. 11 is a diagram for explaining the configuration of a second filter memory according to an embodiment of the present disclosure;

FIG. 12 is a diagram for explaining the configuration of a second filter memory according to an embodiment of the present disclosure;

FIG. 13 is a diagram for explaining the configuration of a first filter memory according to an embodiment of the present disclosure;

FIG. 14 is a diagram for explaining the configuration of a second filter memory according to an embodiment of the present disclosure;

FIG. 15 is a diagram for explaining an operation of performing a convolution operation by using a first weight map and a plurality of convolution filters according to an embodiment of the present disclosure; and

FIG. 16 is a diagram for explaining an operation of generating a final output image by using an input image, an output image, and a second weight map according to an embodiment of the present disclosure.

### DETAILED DESCRIPTION

In the present disclosure, the expression “at least one of a, b or c” may refer to “a”, “b”, “c”, “a and b”, “a and c”, “b and c”, or “all of a, b and c”.

The terms used in the present disclosure will be briefly described, and an embodiment of the present disclosure will be described in detail.

The terms used in the present disclosure are selected from the most widely used general terms possible while considering the functions of the present disclosure, but may vary depending on the intention of engineers in the field, precedents, the emergence of new technologies, and the like. In certain cases, there are terms arbitrarily selected by the applicant, and in such cases, their meanings are described in detail in the corresponding description of an embodiment of the present disclosure. Therefore, the terms used in the present disclosure should be understood based on the meaning of the terms and the overall content of the present disclosure, rather than simply the names of the terms.

Singular expressions include plural expressions unless context clearly indicates otherwise. All terms including technical and scientific terms used in the specification have the same meaning as commonly understood by those of skill in the art to which the present disclosure belongs.

Throughout the present disclosure, unless explicitly described to the contrary, the word “comprise” or “include” and variations such as “comprises” or “includes” or “comprising” or “including”, will be understood to imply the inclusion of stated elements but not the exclusion of any other elements. The terms such as “…unit” or “module” disclosed in the present disclosure mean units for processing at least one function or operation, which may be implemented by hardware, software, or a combination thereof.

According to the situation, the expression “configured to” used in this disclosure may be used as, for example, the expression “suitable for”, “having the capacity to”, “designed to”, “adapted to”, “made to”, or “capable of”. The term “configured to” need not necessarily mean “specifically designed to” in hardware. Instead, the expression “a system configured to” may mean that the device is “capable of” operating together with another device or other components. For example, a “processor configured to (or set to) perform A, B, and C” may mean a dedicated processor (e.g., an embedded processor) for performing a corresponding operation or a generic-purpose processor (e.g., a central processing unit (CPU) or an application processor) which performs corresponding operations by executing one or more software programs which are stored in a memory device.

When a component is referred to in the present disclosure as being ‘connected’ to another component or ‘connected’ to another component, it should be understood that the component may be directly connected to or connected to the other component, but unless there is a specific description to the contrary, it should also be understood that the component may be connected or connected via another component therebetween.

Hereinafter, embodiments of the present disclosure are described in detail such that those of skill in the art may easily implement the same with reference to the accompanying drawings. However, an embodiment of the present disclosure may be implemented in various different forms and is not limited to the embodiments described herein. To clearly explain an embodiment of the present disclosure in the drawings, portions that are not related to explanation are omitted, and similar portions are given similar drawing reference numerals throughout the specification.

Hereinafter, embodiments of the present disclosure will be described in detail with reference to the drawings.

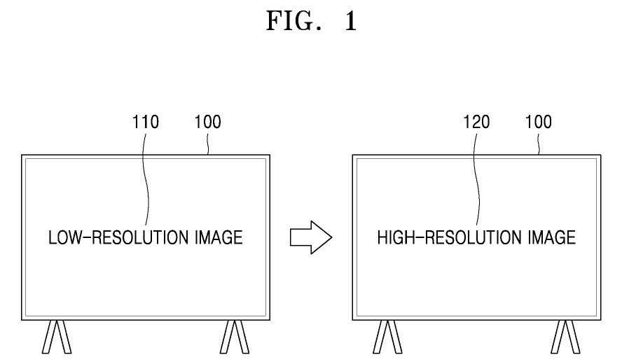

FIG. 1 is a diagram for explaining an operation of an electronic device according to an embodiment of the present disclosure.

Referring to FIG. 1, FIG. 1 illustrates an electronic device 100 according to an embodiment of the present disclosure. In an embodiment, the electronic device 100 in FIG. 1 is illustrated in the form of a television (TV), but the present disclosure is not limited thereto. In an embodiment, the electronic device 100 may be implemented as various types of electronic devices such as a smart phone, a smart TV, a laptop computer, a mobile device, a desktop, a tablet PC, and a wearable device and is not limited to any one type or shape. The electronic device 100 may include a speaker and output audio.

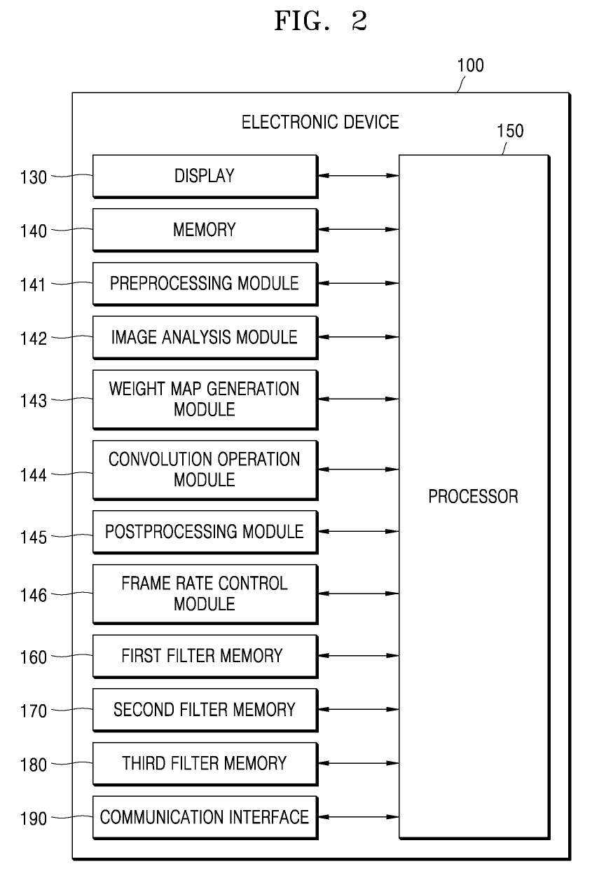

In an embodiment, the electronic device 100 may provide content to a user. The electronic device 100 may display an image or a video to the user through a display 130 (see FIG. 2).

In an embodiment, as the resolution of the display 130 included in the electronic device 100 increases with the advancement of technology, the electronic device 100 may also provide the user with an image having a high resolution. In this case, the electronic device 100 may obtain a low-resolution input image 110 and provide the user with a high-resolution final output image 120 formed by converting the resolution of the obtained input image 110 to a high resolution. However, the present disclosure is not limited thereto, and when the quality of the obtained input image is low, the electronic device 100 may provide the user with a final output image converted to high quality.

In an embodiment, the electronic device 100 may use artificial intelligence to convert the low-resolution input image 110 to the high-resolution final output image 120. In an embodiment, the electronic device 100 may use a super-resolution algorithm through deep learning to receive the low-resolution input image 110 as input and convert the low-resolution input image 110 to the high-resolution final output image 120. In an embodiment, the electronic device 100 may convert the low-resolution input image 110 to the high-resolution final output image 120 by using a super-resolution algorithm through a convolution operation.

In an embodiment, when the electronic device 100 performs a convolution operation on the input image 110, a convolution filter may be used. The electronic device 100 may perform a convolution operation on the input image 110 by using the convolution filter for each frame to generate the final output image 120.

In an embodiment, the electronic device 100 may analyze the input image 110 and perform a convolution operation by using two or more convolution filters on each frame based on the analysis result. In this case, two or more convolution filters may mean that coefficients included in the convolution filters are different. In an embodiment, the coefficients included in the two convolution filters may be different. The electronic device 100 may perform a convolution operation by using the two or more convolution filters that include different coefficients in each frame. In an embodiment, the sizes of the two or more convolution filters may be equal to each other, and the coefficients included in the two or more convolution filters may be different from each other.

By doing so, a convolution operation may be performed on the input image 110 by using the two or more convolution filters that are appropriate for generating the high-resolution final output image, depending on the image features included in the input image 110 (e.g., which include separation between a background and an object, a shape of the object, types of the object and the background, color of the image, and resolution of the image, but are not limited to any one).

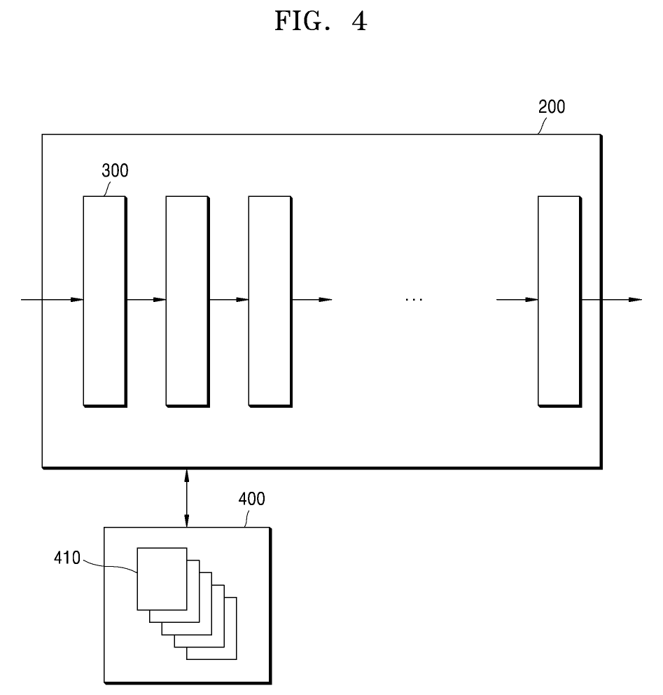

In this case, a convolution neural network 200 (see FIG. 4) for performing a convolution operation may include a plurality of convolution layers 300 (see FIG. 4). In an embodiment, a plurality of convolution filters corresponding to corresponding frames may be used to extract a target feature map from each of the plurality of convolution layers 300 in each frame.

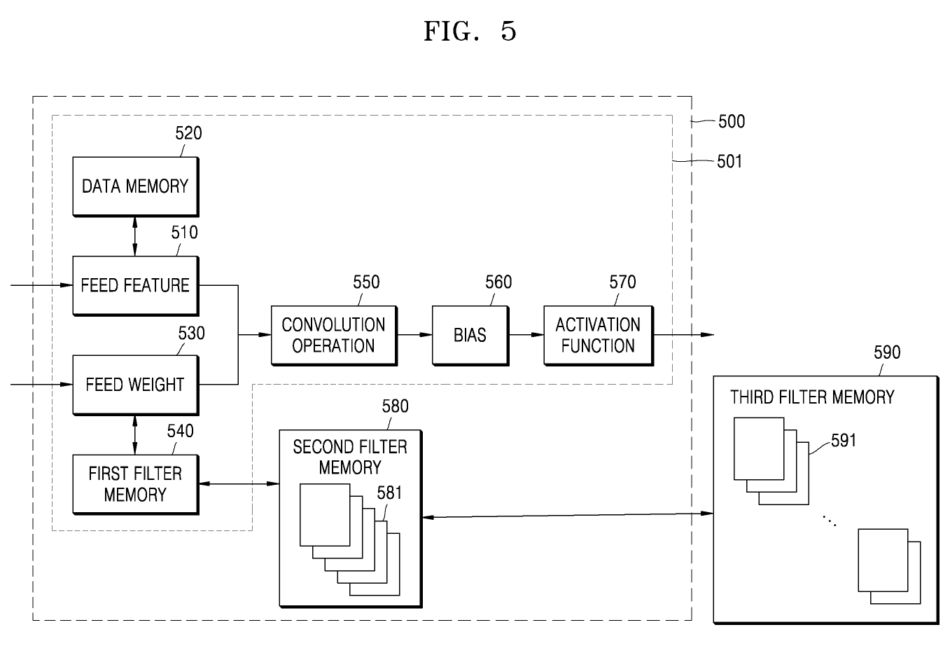

Accordingly, the electronic device 100 may read the plurality of convolution filters corresponding to the corresponding frames from memory 590 (see FIG. 5) in which the plurality of convolution filters are stored and store the convolution filters in memory 540 included in the convolution neural network 200. In this case, reading the plurality of convolution filters from the memory 590 may mean reading different coefficients from the memory 590. Storing the plurality of convolution filters in the memory 540 may mean storing coefficients used in the plurality of convolution filters in the memory 540.

In an embodiment, the memory 590 in which the plurality of convolution filters are stored may be memory hierarchically separated from the memory 540 included in the convolution neural network 200. The electronic device 100 may perform a convolution operation on the input image 110 by using the plurality of convolution filters corresponding to the corresponding frames stored in the memory 540 included in the convolution neural network 200.

In an embodiment, the operation of reading the plurality of convolution filters corresponding to corresponding frames from the memory 590 in which the plurality of convolution filters are stored and storing the read convolution filters in the memory 540 included in the convolution neural network 200 may be performed in a section in which a convolution operation is not performed on the input image 110 through the convolution neural network 200.

In this case, as the number of the plurality of convolution filters used in respective frames increases to generate the high-resolution final output image, a time used for the operation of reading the plurality of convolution filters corresponding to the corresponding frames from the memory 590 in which the plurality of convolution filters are stored and storing the convolution filters in the memory 540 included in the convolution neural network 200 may increase. Accordingly, the convolution filter used to perform a convolution operation in each frame within the section in which the convolution operation is not performed on the input image 110 may not be stored in the memory 540 included in the convolution neural network 200.

In an embodiment of the present disclosure, a separate memory 580 (see FIG. 5, which may be referred to as a ‘second filter memory’ below) having a layer between a layer of the memory 590 (which may be referred to as a ‘third filter memory’ below) in which the plurality of convolution filters are stored and a layer of the memory 540 (which may be referred to as a ‘first filter memory’ below) included in the convolution neural network 200 may be included. The electronic device 100 may read the plurality of convolution filters to be used in a next frame from the third filter memory 590 and store the convolution filters in the second filter memory 580, regardless of a section in which the convolution operation is performed on the input image 110 and a section in which the convolution operation is not performed. In an embodiment of the present disclosure, the second filter memory 580 may be a memory included in the convolution neural network 200. The first filter memory 540 may be a memory of a higher layer than the second filter memory 580.

In an embodiment of the present disclosure, the electronic device 100 may read the plurality of convolution filters to be used in the next frame stored in the second filter memory 580 and store the convolution filters in the first filter memory 540 in the section in which the convolution operation is not performed on the input image 110. The electronic device 100 may perform a convolution operation on the input image 110 by using the plurality of convolution filters stored in the first filter memory 540 in the current frame.

By doing so, the electronic device 100 of the present disclosure may store and use the plurality of convolution filters used to perform a convolution operation in the first filter memory 540 even when the plurality of convolution filters are used to convert the low-resolution input image 110 to the high-resolution final output image 120 by using a super-resolution algorithm through a convolution operation.

It will be appreciated by those of skill in the art that the effects that could be achieved with the present disclosure are not limited to what has been particularly described hereinabove and other advantages of the present disclosure will be more clearly understood from the above detailed description.

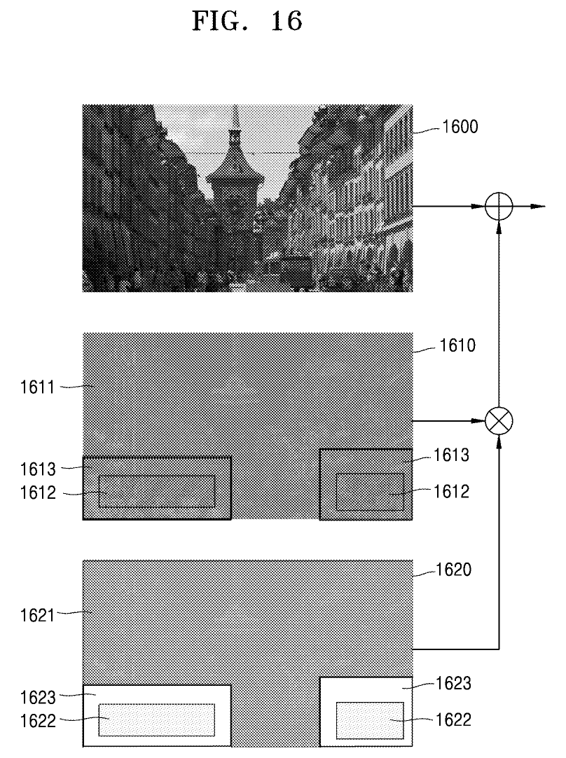

In an embodiment of the present disclosure, the final output image 120 may be an image generated based on the input image 110 and an output image 1610 (see FIG. 16) generated by providing the input image 110 to the convolution neural network 200. In an embodiment of the present disclosure, the output image 1610 is an image generated to increase the resolution of the input image 110, and the final output image 120 having a high resolution may be generated by a sum operation of the input image 110 and the output image 1610.

In an embodiment of the present disclosure, the electronic device 100 may generate the final output image 120 by a sum operation of summing the input image 110 and a result of a multiplication operation of multiplying a second weight map 1620 including respective weights of a plurality of output areas included in the output image 1610. The electronic device 100 may change the influence of the output image 1610 generated through the convolution neural network 200 on the input image 110 based on the input image 110 or an input of a user using the electronic device 100, thereby generating the final output image 120. By doing so, the electronic device 100 may generate the final output image 120 formed by adjusting the resolution, brightness, sharpness, or contrast of a certain area of the input image 110.

It will be appreciated by those of skill in the art that the effects that could be achieved with the present disclosure are not limited to what has been particularly described hereinabove and other advantages of the present disclosure will be more clearly understood from the above detailed description.

FIG. 2 is a diagram for explaining the configuration of an electronic device according to an embodiment of the present disclosure.

Referring to FIGS. 1 and 2, in an embodiment of the present disclosure, the electronic device 100 may include the display 130, memory 140, a preprocessing module 141, an image analysis module 142, a weight map generation module 143, a convolution operation module 144, a postprocessing module 145, a frame rate control module 146, at least one processor 150, a first filter memory 160, a second filter memory 170, a third filter memory 180, and a communication interface 190. In an embodiment, not all of the components illustrated in FIG. 2 are used. The electronic device 100 may be implemented with more components than those illustrated in FIG. 2, or may be implemented with fewer components.

In an embodiment of the present disclosure, the display 130, the memory 140, the preprocessing module 141, the image analysis module 142, the weight map generation module 143, the convolution operation module 144, the postprocessing module 145, the frame rate control module 146, the at least one processor 150, the first filter memory 160, the second filter memory 170, the third filter memory 180, and the communication interface 190 may be electrically and/or physically connected to each other.

Hereinafter, the same components as those described with reference to FIG. 1 are denoted by the same reference numerals and descriptions thereof are omitted.

In an embodiment of the present disclosure, the display 130 may include any one of a liquid crystal display, a plasma display, an organic light emitting diode display, and an inorganic light emitting diode display. However, the present disclosure is not limited thereto, and the display 130 may include other types of displays for providing an image to a user. In an embodiment, the at least one processor 150 may display the final output image 120 through the display 130 and provide the final output image 120 to the user.

In an embodiment of the present disclosure, the memory 140 may store instructions or program codes for performing functions or operations of the electronic device 100. The instructions, algorithms, data structures, program codes, and application programs stored in the memory 140 may be implemented in a programming or scripting language, for example, C, C++, Java, or assembler.

In an embodiment of the present disclosure, various types of modules that are to be used to convert the low-resolution input image 110 through the electronic device 100 to generate the high-resolution final output image 120 may be stored in the memory 140. Various types of modules that are to be used to perform a super-resolution operation using a convolution operation to generate the high-resolution final output image 120 from the low-resolution input image 110 may be stored in the memory 140. Various types of modules that are to be used to provide sound of an image through an audio device when operating the electronic device 100 may be stored in the memory 140. In an embodiment of the present disclosure, the ‘module’ included in the memory 140 may mean a unit that processes a function or operation performed by the at least one processor 150. The ‘module’ included in the memory 140 may be implemented as software such as instructions, algorithms, data structures, or program codes.

In an embodiment, the preprocessing module 141, the image analysis module 142, the weight map generation module 143, the convolution operation module 144, the postprocessing module 145, and the frame rate control module 146 are illustrated as separate components from the memory 140, but the present disclosure is not limited thereto. In an embodiment, each of the preprocessing module 141, the image analysis module 142, the weight map generation module 143, the convolution operation module 144, the postprocessing module 145, and the frame rate control module 146 may be implemented and stored in the memory 140 as software such as instructions or program codes.

In an embodiment of the present disclosure, the preprocessing module 141, the image analysis module 142, the weight map generation module 143, the convolution operation module 144, the postprocessing module 145, and the frame rate control module 146 may be stored in the memory 140. However, not all of the modules shown in FIG. 2 are used. The memory 140 may store more or fewer modules than the modules shown in FIG. 2. Hereinafter, a case in which the preprocessing module 141, the image analysis module 142, the weight map generation module 143, the convolution operation module 144, the postprocessing module 145, and the frame rate control module 146 are implemented in software will be described. In an embodiment of the present disclosure, the preprocessing module 141 may be configured with instructions or program codes relating to an operation or function that preprocesses the input image 110. In an embodiment, the preprocessing module 141 may be configured with instructions or program codes relating to an operation or a function such as wrangling, transformation, integration, cleaning, reduction, discretization, or denoising.

In an embodiment of the present disclosure, the at least one processor 150 may execute the instructions or program codes of the preprocessing module 141 to preprocess the obtained input image 110.

In an embodiment of the present disclosure, the image analysis module 142 may be configured with instructions or program codes relating to an operation or function that analyzes the input image 110. In an embodiment, the image analysis module 142 may include an algorithm for classifying the type of input image. In an embodiment, the image analysis module 142 may include an algorithm for detecting an object included in the input image. However, the present disclosure is not limited thereto, and the image analysis module 142 may include an algorithm for segmenting an object included in at least one image 111 from the at least one image. The image analysis module 142 may be configured with instructions or program codes relating to an operation or function that analyzes the type, shape, color, brightness, contrast, and the like of an object and a background included in the input image 110.

In an embodiment of the present disclosure, the at least one processor 150 may execute the instruction, program code, or algorithm of the image analysis module 142 to analyze the obtained input image 110 and to separate a background and an object included in the input image 110. The at least one processor 150 may execute the instruction, program code or algorithm of the image analysis module 142 to analyze the type of object, shape of object, size of object, background and brightness of object, contrast ratio, brightness ratio, and color included in the input image 110.

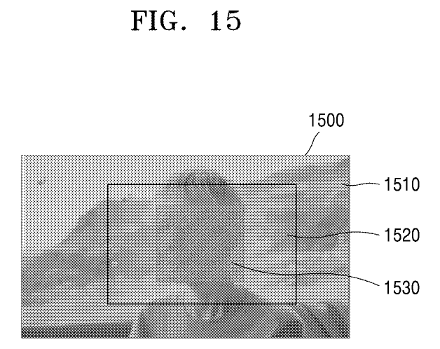

In an embodiment of the present disclosure, the weight map generation module 143 may be configured with instructions or program codes relating to an operation or function that generates a weight map based on the result of analyzing the input image 110 through the image analysis module 142. In an embodiment, the weight map may include a first weight map 1500 (see FIG. 15) and a second weight map 1620 (see FIG. 16).

In an embodiment, the first weight map 1500 may be a map that includes respective weights of a plurality of convolution filters to be used when dividing the input image 110 into a plurality of areas and performing a convolution operation on each of the divided plurality of areas. In an embodiment, the first weight map 1500 may be a map including the respective weights of the plurality of convolution filters respectively used for the plurality of areas that are divided from the input image 110 when performing a convolution operation on the input image 110 in one frame.

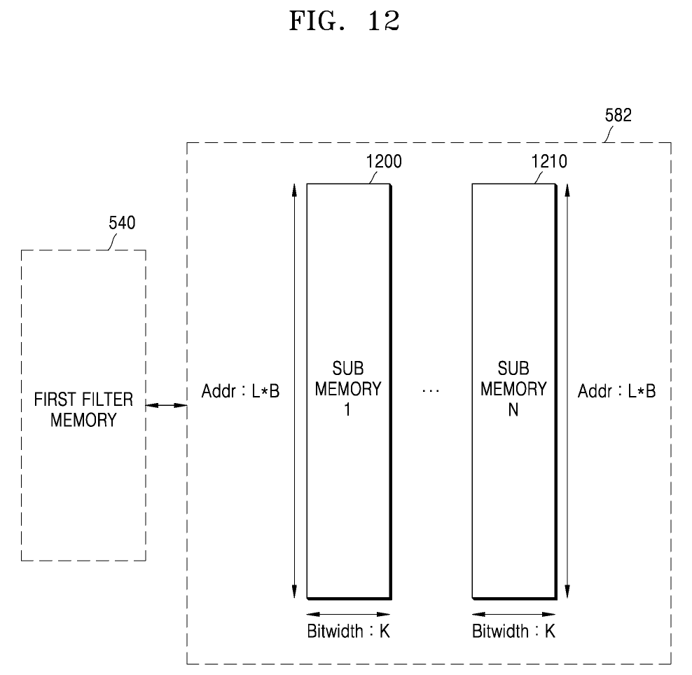

In an embodiment, the respective weights of the plurality of convolution filters according to the analysis result of the input image may be a value determined in a training stage of the convolution neural network 200. Hereinafter, the first weight map 1500 will be described with reference to FIG. 12.

In an embodiment, the second weight map 1620 may be a map including the respective weights of the plurality of output images included in the output image 1610 (see FIG. 16) generated by performing a convolution operation on the input image 110. In an embodiment, the second weight map 1620 may be a map for determining an extent to which the output image 1610 generated through the convolution neural network 200 is integrated into the input image 110 for each of the plurality of output images that distinguish the output image 1610 when the final output image 120 is generated.

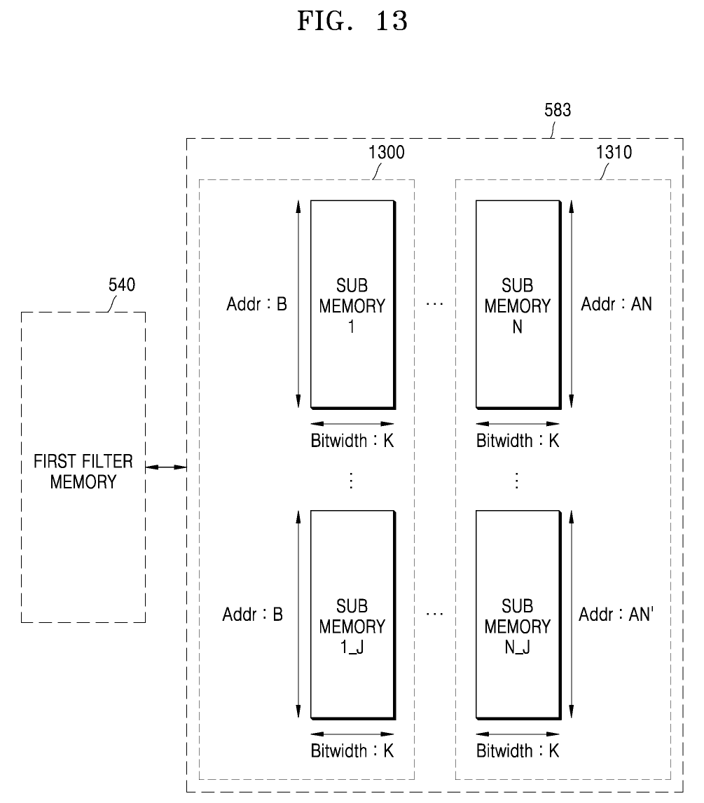

In an embodiment, the respective weights of the plurality of output images according to the analysis result of the input image may be a value determined in a training stage of the convolution neural network 200. The present disclosure is not limited thereto, and the second weight map 1620 may also be generated based on user input obtained from a user through a user interface included in the electronic device 100 to determine an extent to which the resolution of the input image 110 is converted to a high resolution. Hereinafter, the second weight map 1620 will be described with reference to FIG. 13.

In an embodiment of the present disclosure, the convolution operation module 144 may be configured with instructions or program codes relating to an operation or function that converts a low-resolution image to a high-resolution image. In an embodiment, the convolution operation module 144 may include a super-resolution model.

In an embodiment of the present disclosure, the at least one processor 150 may execute instructions or program codes of the convolution operation module 144 to perform a convolution operation on the input image 110 to generate the output image 1610. Hereinafter, the convolution operation module 144 will be described below with reference to FIGS. 4 to 6.

In an embodiment of the present disclosure, the postprocessing module 145 may be configured with instructions or program codes relating to an operation or a function that performs image postprocessing of the output image 1610 generated through the convolution operation module 144. In an embodiment, the postprocessing module 145 may be configured with instructions or program codes relating to an operation or function that performs postprocessing, such as color correction, noise removal, and image quality correction, of the output image 1610.

In an embodiment, the postprocessing module 145 may be configured with instructions or program codes relating to an operation or a function that performs a sum operation of the input image 110 and the output image 1610 to generate the final output image 120. In an embodiment, the postprocessing module 145 may be configured with instructions or program codes relating to an operation or a function that performs a multiplication operation between the second weight map 1620 and the output image 1610, and performing a sum operation between the result of the multiplication operation and the input image 110 to generate a final output image 120.

In an embodiment, the at least one processor 150 may execute an instruction or a program code of the postprocessing module 145 to perform postprocessing on the output image 1610. The at least one processor 150 may execute the instruction or the program code of the postprocessing module 145 to generate the final output image 120 based on the input image 110, the output image 1610, and the second weight map 1620.

In an embodiment, the frame rate control module 146 may be configured with instructions or program codes relating to an operation or a function that controls a frame rate at which the final output image 120 is displayed on the display 130. In an embodiment, the frame rate control module 146 may be configured with instructions or program codes relating to an operation or a function that determines a frame rate of the final output image 120 displayed through the display 130 based on the power consumption of the electronic device 100, battery capacity, or type of the final output image 120.

In an embodiment, the at least one processor 150 may execute instructions or program codes of the frame rate control module 146 to determine the frame rate of the final output image 120 and display the final output image 120 on the display 130.

However, the present disclosure is not limited thereto, and at least one module of the preprocessing module 141, the image analysis module 142, the weight map generation module 143, the convolution operation module 144, the postprocessing module 145, or the frame rate control module 146 may be designed as hardware by using a hardware description language, for example, Verilog or VHSIC hardware description language (VHDL), and implemented as an application-specific integrated circuit (ASIC), a field-programmable gate array (FPGA), or a hardware accelerator device.

In an embodiment, the at least one processor 150 may be configured as at least one of a central processing unit, a microprocessor, a graphic processing unit, an application processor (AP), application specific integrated circuits (ASICs), digital signal processors (DSPs), digital signal processing devices (DSPDs), programmable logic devices (PLDs), field programmable gate arrays (FPGAs), or artificial intelligence (AI)-dedicated processors designed as a hardware structure specialized for learning and processing a neural processing unit or an AI model, but is not limited thereto.

In an embodiment of the present disclosure, the at least one processor 150 may be configured as a circuitry such as a System on Chip (SoC) or an integrated circuit (IC). The at least one processor 150 may include a processing circuitry.

In an embodiment, the at least one processor 150 may execute various types of modules stored in the memory 140. In an embodiment, the at least one processor 150 may execute the preprocessing module 141, the image analysis module 142, the weight map generation module 143, the convolution operation module 144, the postprocessing module 145, and the frame rate control module 146 stored in the memory 140. In an embodiment, the at least one processor 150 may execute at least one instruction that configures various types of modules stored in the memory 140.

In an embodiment of the present disclosure, the at least one processor 150 may execute at least one module of the preprocessing module 141, the image analysis module 142, the weight map generation module 143, the convolution operation module 144, the postprocessing module 145, or the frame rate control module 146 stored in the memory 140.

In an embodiment of the present disclosure, the at least one processor 150 may include a plurality of processors. In an embodiment of the present disclosure, at least one module of the preprocessing module 141, the image analysis module 142, the weight map generation module 143, the convolution operation module 144, the postprocessing module 145, or the frame rate control module 146 stored in the memory 140 may be executed by any one of a plurality of processors.

The at least one processor 150 may execute a program or at least one instruction stored in the memory 140 to process data according to a predefined operation rule.

However, the present disclosure is not limited thereto, and the at least one processor 150 may execute at least one module of the preprocessing module 141, the image analysis module 142, the weight map generation module 143, the convolution operation module 144, the postprocessing module 145, or the frame rate control module 146 that is configured separately from the memory 140.

In an embodiment of the present disclosure, the first filter memory 160 may store a first convolution filter used for a convolution operation in the current frame. In an embodiment, when the convolution operation is performed across a plurality of convolution layers, the first filter memory 160 may store a plurality of first convolution filters used in the plurality of convolution layers in the current frame. In an embodiment, when the convolution operation is performed on the input image 110 by using two or more sub convolution filters in each of the plurality of convolution layers, a plurality of sub convolution filters used in the current frame may be stored in the first filter memory 160. In this case, each of the plurality of sub convolution filters may include different coefficients.

In an embodiment of the present disclosure, the first filter memory 160 may be designed to have a structure having a higher layer than the second filter memory 170 and the third filter memory 180. In an embodiment, the at least one processor 150 may execute instructions or program codes of the convolution operation module 144 to read and use a convolution filter for performing a convolution operation on the input image 110 in the current frame from the first filter memory 160. In an embodiment, the first filter memory 160 may be a memory included in the convolution neural network 200 (see FIG. 4).

In an embodiment of the present disclosure, the second filter memory 170 may store a second convolution filter used for a convolution operation in a next frame. In an embodiment, when the convolution operation is performed across a plurality of convolution layers, the second filter memory 170 may store a plurality of second convolution filters used in the plurality of convolution layers in the next frame. In an embodiment, when the convolution operation is performed on the input image 110 by using two or more sub convolution filters in each of the plurality of convolution layers, a plurality of sub convolution filters used in the next frame may be stored in the second filter memory 170.

In an embodiment of the present disclosure, the second filter memory 170 may be designed to have a structure having a higher layer than the third filter memory 180. In an embodiment, the at least one processor 150 may execute instructions or program codes of the convolution operation module 144 and may read and use a second convolution filter determined to be in the next frame from the second filter memory 170 when performing a convolution operation on the input image 110. In an embodiment, the at least one processor 150 may store the second convolution filter read from the second filter memory 170 in the first filter memory 160, and then perform a convolution operation by using the second convolution filter stored in the first filter memory 160 as a first convolution filter in the next frame.

In an embodiment of the present disclosure, the second filter memory 170 may be a memory included in the convolution neural network 200.

In an embodiment of the present disclosure, the third filter memory 180 may store a plurality of convolution filters used in a convolution operation during a plurality of frames. In an embodiment, when the convolution operation is performed on the input image by using two or more sub convolution filters in each of the plurality of convolution layers, the plurality of sub convolution filters used in the plurality of frames may be stored in the third filter memory 180.

In an embodiment, the plurality of convolution filters stored in the first filter memory 160, the second filter memory 170, and the third filter memory 180 may include convolution filters used in the convolution neural network 200 including an AI model trained using a data set including pairs of low-resolution images and high-resolution images.

In an embodiment of the present disclosure, the third filter memory 180 may be designed to have a structure having a lower layer than the first filter memory 160 and the second filter memory 170. In an embodiment, the at least one processor 150 may execute the instructions or program codes of the convolution operation module 144 to read a convolution filter used to perform a convolution operation on the input image 110 from the third filter memory 180.

In an embodiment of the present disclosure, the memory 140, the first filter memory 160, the second filter memory 170, and the third filter memory 180 may each include at least one of a flash memory type, hard disk type, multimedia card micro type, and card type memories (e.g., SD or XD memories), a random access memory (RAM), a static random access memory (SRAM), a read-only memory (ROM), an electrically erasable programmable read-only memory (EEPROM), a programmable read-only memory (PROM), a mask ROM, a flash ROM, a flash ROM, a hard disk drive (HDD), or a solid state drive (SSD).

In an embodiment, the memory 140, the first filter memory 160, the second filter memory 170, and the third filter memory 180 may be physically separate from each other. However, the present disclosure is not limited thereto, and at least one of the memory 140, the first filter memory 160, the second filter memory 170, or the third filter memory 180 may be one logically separated memory.

In an embodiment, the communication interface 190 may perform data communication with an external server according to control of the at least one processor 150. The communication interface 190 may perform data communication not only with an external server but also with other external electronic devices.

In an embodiment, the communication interface 190 may perform data communication with a server or other external electronic devices by using at least one of data communication methods including wired LAN, wireless LAN, Wi-Fi, Bluetooth, ZigBee, Wi-Fi direct (WFD), infrared data association (IrDA), Bluetooth low energy (BLE), near field communication (NFC), wireless broadband Internet (Wibro), world interoperability for microwave access (WiMAX), shared wireless access protocol (SWAP), wireless gigabit alliance (WiGig), or RF communication.

In an embodiment, the at least one processor 150 may be provided with a trained convolution neural network through the communication interface 190.

However, the present disclosure is not limited thereto, and the electronic device 100 may further include an input/output interface. The input/output interface may include at least one of input/output methods including high-definition multimedia interface (HDMI), digital visual interface (DVI), or universal serial bus (USB). The electronic device 100 may also receive the input image 110 from an external electronic device through the input/output interface.

The electronic device 100 may provide the final output image 120 converted to high definition to an external server through a communication interface 190, or may provide the final output image 120 to the external electronic device through the input/output interface.

The present disclosure is not limited thereto, and the electronic device 100 may further include a user interface for obtaining user input. In an embodiment, the user interface may include a touch unit, a push button, a voice recognition unit, and a gesture recognition unit. In an embodiment, the at least one processor 150 may obtain a user input through the user interface to determine an extent to which the resolution of the input image 110 is converted from a low resolution to a high resolution.

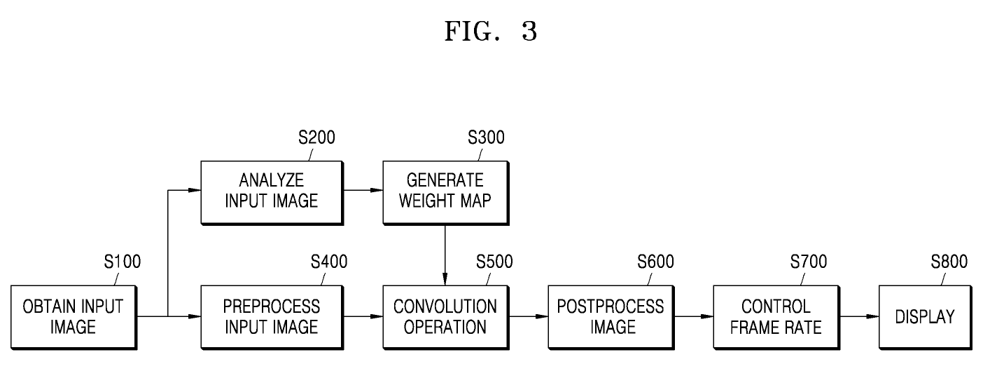

FIG. 3 is a diagram for explaining an operation of an electronic device according to an embodiment of the present disclosure.

Referring to FIGS. 1, 2 and 3, in an embodiment of the present disclosure, an operating method of the electronic device 100 may include obtaining the input image 110 (S100). The electronic device 100 may obtain the input image 110 from an external server or an external electronic device through the communication interface 190 or the input/output interface. The electronic device 100 may also generate and obtain the input image 110.

In an embodiment of the present disclosure, the operating method of the electronic device 100 may include analyzing the input image 110 (S200). In an embodiment, in the analyzing of the input image 110, the at least one processor 150 may execute an instruction or program code of the image analysis module 142 to divide the input image 110 into a plurality of areas on which a convolution operation is to be performed using different sub convolution filters.

In an embodiment of the present disclosure, the operating method of the electronic device 100 may include generating a weight map (S300). In an embodiment, in the generating of the weight map (S300), the at least one processor 150 may execute instructions or program codes of the weight map generation module 143 to generate at least one of the first weight map 1500 or the second weight map 1620. In an embodiment of the present disclosure, the analyzing of the input image (S200) and the generating the weight map (S300) are illustrated as separate operations in FIG. 3, but the present disclosure is not limited thereto. In an embodiment, the analyzing of the input image and generating of the weight map may be performed in a single operation.

In an embodiment of the present disclosure, the operating method of the electronic device 100 may include preprocessing the input image 110 (S400). In an embodiment, in the preprocessing of the input image 110 (S400), the at least one processor 150 may execute the instructions or program codes of the preprocessing module 141 to preprocess the input image 110. In FIG. 3, the analyzing of the input image 110 (S200) is illustrated as being performed separately from the preprocessing of the input image (S400), but the present disclosure is not limited thereto. The analyzing of the input image 110 (S200) may be performed after the preprocessing of the input image (S400).

In an embodiment of the present disclosure, the operating method of the electronic device 100 may include performing a convolution operation on the input image 110 (S500). In an embodiment, in the performing of the convolution operation (S500), the at least one processor 150 may execute instructions or program codes of the convolution operation module 144 to perform the convolution operation on the input image 110. In an embodiment, in the performing of the convolution operation (S500), the convolution operation may be performed using a first weight map generated in the generating of the weight map (S300). Hereinafter, the performing a convolution operation (S500) will be described below with reference to FIG. 5.

In an embodiment of the present disclosure, the operating method of the electronic device 100 may include postprocessing an image (S600). In the postprocessing of the image (S600), the at least one processor 150 may execute instructions or program codes of the postprocessing module 145 to perform postprocessing on the output image 1610 or the final output image 120 generated in the performing of the convolution operation (S500).

In an embodiment of the present disclosure, the operating method of the electronic device 100 may include controlling a frame rate (S700). In the controlling of the frame rate (S700), the at least one processor 150 may execute instructions or program codes of the frame rate control module 146 to determine the frame rate of the final output image 120 to be displayed on the display 130.

In an embodiment of the present disclosure, the operating method of the electronic device 100 may include displaying the final output image 120 (S800). In the displaying of the final output image 120 (S800), the at least one processor 150 may control the display 130 to display the final output image 120.

However, the present disclosure is not limited thereto, and the operating method of the electronic device 100 may further include operations other than the operations illustrated in FIG. 3, or may not include some of the operations illustrated in FIG. 3 (e.g., the preprocessing of the input image (S400), the postprocessing of the image (S600), or the controlling of the frame rate (S700)).

FIG. 4 is a diagram for explaining an operation of performing a convolution operation by an electronic device according to an embodiment of the present disclosure.

Referring to FIGS. 1, 2 and 4, in an embodiment, FIG. 4 illustrates the convolution neural network 200 for executing instructions or program codes of the convolution operation module 144 by the at least one processor 150 to perform a convolution operation in the performing of the convolution operation (S500). However, the present disclosure is not limited thereto, and the convolution operation module 144 may be implemented in hardware, and the performing of the convolution operation may be performed in each hardware block included in the convolution operation module. Hereinafter, the operation of the convolution operation module 144 implemented in hardware will be described below with reference to FIG. 5.

In an embodiment of the present disclosure, the at least one processor 150 may perform a predefined task by using the convolution neural network 200. The predefined task may be, for example, a super-resolution task that takes the low-resolution input image 110 as input and generates the high-resolution final output image 120, but is not limited thereto.

In an embodiment of the present disclosure, the convolution neural network 200 may be implemented using various known deep neural network architectures and algorithms appropriate for super resolution, or through modifications of various known deep neural network architectures and algorithms. For example, the convolution neural network 200 may be implemented through a super-resolution convolutional neural network (SRCNN), an enhanced deep super-resolution (EDSR), a super-resolution generative adversarial network (SRGAN), and modifications thereof, but is not limited to the examples described above.

In an embodiment of the present disclosure, the at least one processor 150 may extract various features from the low-resolution input image 110 by using the convolution neural network 200 and infer pixel information included in the input image 110 from the extracted features to perform resolution upscaling.

In an embodiment of the present disclosure, the convolution neural network 200 may include the plurality of neural network layers 300 (e.g., convolution layer). In each of the plurality of convolution layers 300, the convolution operation may be performed by a plurality of convolution filters 410. In each of the plurality of convolution layers 300, the convolution operation may be performed using a feature map output from a previous convolution layer and a convolution filter corresponding to each convolution layer, and a bias value may be added to the performed result or a feature map may be output using an activation function.

In an embodiment of the present disclosure, the at least one processor 150 may read and use the plurality of convolution filters 410 used for the convolution operation from a filter memory 400 when performing a convolution operation by using the convolution neural network 200. In this case, when performing the convolution operation across a plurality of frames, the at least one processor 150 may read and use a plurality of convolution filters used for the corresponding frame among the plurality of convolution filters 410 included in the filter memory 400. In this case, the filter memory 400 illustrated in FIG. 4 may refer to the first filter memory 160, the second filter memory 170, and the third filter memory 180. The at least one processor 150 may read the plurality of convolution filters used for each frame based on a hierarchical structure of the first filter memory 160, the second filter memory 170, and the third filter memory 180.

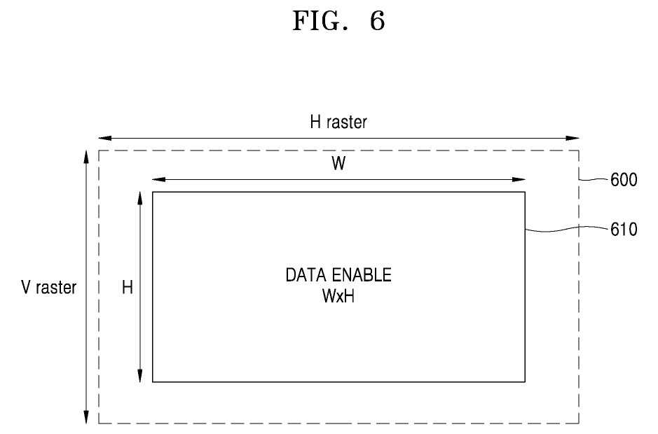

FIG. 5 is a diagram illustrating a convolution operation module implemented in hardware according to an embodiment of the present disclosure. FIG. 6 is a diagram for explaining an operation of obtaining a convolution filter from a memory by an electronic device according to an embodiment of the present disclosure.

Referring to FIGS. 2, 4 and 5, in an embodiment, FIG. 5 illustrates a convolution block 500 representing the convolution neural network 200 representing a convolution operation module implemented in hardware, and a layer block 501 representing a convolution operation of one convolution layer among the plurality of convolution layers 300 included in the convolution neural network 200. In an embodiment, FIG. 5 illustrates the convolution block 500 including one layer block 501, but the present disclosure is not limited thereto, and the convolution block 500 may include a plurality of layer blocks respectively corresponding to the plurality of convolution layers 300. Hereinafter, for convenience of explanation, the convolution operation is described using a plurality of blocks included in one layer block 501, but this may be applied to each of a plurality of layer blocks to be included in the convolution block 500.

In an embodiment of the present disclosure, the convolution block 500 may include the layer block 501 and the second filter memory 580. In an embodiment of the present disclosure, the layer block 501 may include a feature feed block 510, a data memory 520, a feed weight block 530, the first filter memory 540, a convolution operation block 550, a bias block 560, and an activation function block 570. In an embodiment, when the convolution block 500 includes a plurality of layer blocks, each of the plurality of layer blocks may include a feature feed block, a data memory, a feed weight block, a first filter memory, a convolution operation block, a bias block, and an activation function block. However, the present disclosure is not limited thereto, and the plurality of layer blocks may share and use at least one block among the feature feed block, the data memory, the feed weight block, the first filter memory, the convolution operation block, the bias block, and the activation function block.

In an embodiment, each block included in the layer block 501 may be components (e.g., a control unit, a memory, or an arithmetic unit (ALU)) for performing at least a part of the convolution operation in each block. Each block included in the layer block 501 described below may be appropriately applied with known components according to its function, and thus a description of detailed components of each block is omitted. The convolution neural network is explained assuming the convolution neural network is pretrained.

In this case, the data memory 520, the first filter memory 540, and the second filter memory 580 included in the convolution block 500 may be physically distinct separate memories, or may be logically distinct as one memory.

In an embodiment of the present disclosure, the feature feed block 510 may receive feature data, which is a result value calculated in a previous convolution layer, and feed the feature data to the convolution operation block 550. In this case, the feature feed block 510 may store the provided feature data in the data memory 520 inside the layer block 501. The feature feed block 510 may store the feature data provided to the data memory 520, and read feature data having a size corresponding to the size of a convolution filter from the data memory 520 and feed the feature data to the convolution operation block 550 such that the convolution operation block 550 performs the convolution operation.

In an embodiment of the present disclosure, the feed weight block 530 may feed, to the convolution operation block 550, the convolution filter fed to the convolution operation block 550. In this case, the convolution filter fed to the convolution operation block 550 may be a convolution filter used to perform a convolution operation in the current frame.

In an embodiment of the present disclosure, the feed weight block 530 may read the first convolution filter used for the convolution operation in the current frame stored in the first filter memory 540 within the layer block 501 and feed the first convolution filter to the convolution operation block 550. In an embodiment, the first convolution filter stored in the first filter memory 540 may be a second convolution filter stored in the second filter memory 580 within the convolution block 500 in the previous frame, which the feed weight block 530 reads and stores in the first filter memory 540.

In an embodiment of the present disclosure, the second filter memory 580 may store a second convolution filter 581 used for a convolution operation in a next frame. The feed weight block 530 may read the second convolution filter 581 from the second filter memory 580 and store the second convolution filter 581 in the first filter memory 540, and provide the second convolution filter 581 stored in the first filter memory 540 as the first convolution filter to the convolution operation block 550 in the next frame.

In an embodiment of the present disclosure, coefficients included in the first convolution filter stored in the first filter memory 540 in the current frame and coefficients included in the second convolution filter stored in the second filter memory 580 may be different from each other.

In an embodiment of the present disclosure, FIG. 5 illustrates the third filter memory 590 being located outside the convolution block 500, but the present disclosure is not limited thereto. In an embodiment, the third filter memory 590 may also be located within the convolution block 500. In this case, the third filter memory 590 may be physically separated from the second filter memory 580. The third filter memory 590 may be a memory with a lower layer than the second filter memory 580. Hereinafter, the third filter memory 590 is described as a memory located outside the convolution block 500.

In an embodiment of the present disclosure, the third filter memory 590 outside the convolution block 500 may store a plurality of convolution filters 591 used for a convolution operation performed in the convolution operation block 550 during a plurality of frames. In an embodiment, the plurality of convolution filters 591 stored in the third filter memory 590 may include coefficients calculated during a training process of the convolution neural network 200. In an embodiment, the plurality of convolution filters 591 stored in the third filter memory 590 may be convolution filters including different coefficients.

In an embodiment of the present disclosure, the feed weight block 530 may read the second convolution filter 581 to be used in the next frame among the plurality of convolution filters 591 stored in the third filter memory 590 and store the second convolution filter 581 in the second filter memory 580. In this case, the second convolution filter 581 to be used in the next frame may be determined based on the result of analyzing the obtained input image 110.

In an embodiment, an inter-integrated circuit (I2C) interface, an open core protocol (OCP) interface, or the like may be used between the feed weight block 530, the first filter memory 540, the second filter memory 580, and the third filter memory 590, but is not limited thereto.

Referring to FIG. 6, in an embodiment, FIG. 6 illustrates a frame 600 of the input image 110 (see FIG. 1) obtained by the electronic device 100. In an embodiment, the frame 600 of the input image 110 may have a specification. The frame 600 of the input image 110 may have a horizontal raster size and a vertical raster size, and a horizontal size W and a vertical size H of a data enable area 610 in which actual image data inputs may be in an area formed by the horizontal raster and the vertical raster.

In an embodiment, the electronic device 100 may identify the size of the horizontal raster and the size of the vertical raster of the input image 110. For example, when the electronic device 100 obtains the input image 110 having a resolution of 4K, the sizes of the identified horizontal raster and vertical raster may be 4400*2250, and in this case, the horizontal size W and vertical size H of the data enable area 610 may be 3840*2160.

In an embodiment, when the frame 600 of the input image 110 is referred to as one frame, the one frame may be divided into a first section and a second section. In an embodiment, the first section may be a data unable area in which no image data is input in the frame 600 of the input image 110. The second section may be the data enable area 610 in which image data is input in the frame 600 of the input image 110. In an embodiment, the data enable area may be referred to as a section in which the input image 110 is provided.

Referring to FIGS. 5 and 6, in an embodiment, the convolution operation block 550 may perform a convolution operation in the second section in which image data is input. The feed weight block 530 may read a convolution filter from the second filter memory 580 in the first section and store the convolution filter in the first filter memory 540. The feed weight block 530 may read the convolution filter from the first filter memory 540 in the second section and provide the convolution filter to the convolution operation block 550.

In an embodiment of the present disclosure, the second filter memory 580 may read the second convolution filter 581 from the second filter memory 580 in a first section and store the read second convolution filter 581 in the first filter memory 540. The feed weight block 530 may read the second convolution filter 581 stored in the first filter memory 540 in the second section of the next frame as the first convolution filter and provide the second convolution filter 581 to the convolution operation block 550.

In an embodiment of the present disclosure, the feed weight block 530 may read the second convolution filter 581 to be used in the next frame from third filter memory 590 in one frame and store the second convolution filter 581 in the second filter memory 580. The feed weight block 530 may read the second convolution filter 581 to be used in the next frame from the third filter memory 590 in either the first or second section of the current frame and store the second convolution filter 581 in the second filter memory 580. The feed weight block 530 may read the second convolution filter 581 from the second filter memory 580 in a section after the image data is input in the current frame or in a section before the image data is input in the next frame and store the second convolution filter 581 in the first filter memory 540. The feed weight block 530 may provide the second convolution filter 581 stored in the first filter memory 540 to the convolution operation block 550 as the first convolution filter in the second section, which is the section in which the image data is input in the next frame.

By doing so, regardless of whether a convolution operation is performed in the current frame, the second convolution filter 581 to be used in the next frame may be read from the third filter memory 590 and stored in the second filter memory 580, and the second convolution filter 581 stored in the second filter memory 580 in the first section may be read and stored in the first filter memory 540. Accordingly, even when a plurality of convolution filters with different coefficients are used in a plurality of convolution layers included in the convolution neural network 200 in each frame, it may be possible to prevent a delay in performing a convolution operation in the second section in which data is input or a case in which a convolution filter may not be used. Accordingly, the electronic device 100 may generate the high-resolution final output image 120.

It will be appreciated by those of skill in the art that the effects that could be achieved with the present disclosure are not limited to what has been particularly described hereinabove and other advantages of the present disclosure will be more clearly understood from the above detailed description.

In an embodiment of the present disclosure, the bias block 560 may adjust input to the activation function block 570 by adding a bias to a value calculated by the convolution operation block 550.

In an embodiment of the present disclosure, the activation function block 570 may calculate an output feature by applying an activation function to the value provided by the bias block 560. The activation function may be used, for example, rectified linear unit (ReLU), or sigmoid, but is not limited thereto.

In an embodiment, FIG. 5 illustrates blocks and operations implemented in hardware of one of the plurality of convolution layers 300 included in the convolution neural network 200. In an embodiment, each of the plurality of convolution layers 300 included in the convolution neural network 200 may be implemented as the layer block 501 illustrated in FIG. 5. In detail, when the layer block 501 performs a convolution operation of one convolution layer included in the convolution neural network 200, output feature data, which is the result of processing the input feature data, is obtained. The obtained output feature data may be fed as input feature data to the next convolution layer.

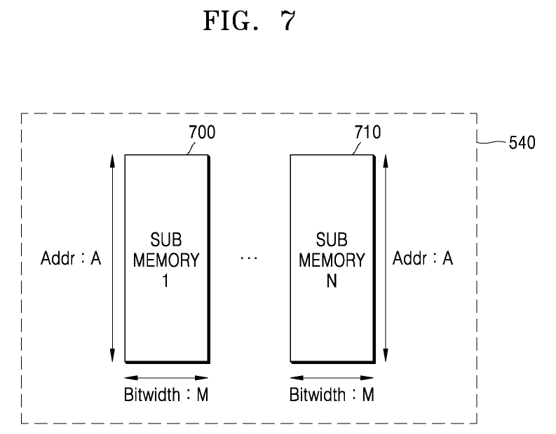

FIG. 7 is a diagram for explaining the configuration of a first filter memory according to an embodiment of the present disclosure.

Referring to FIGS. 5 and 7, in an embodiment, FIG. 7 illustrates the configuration of the first filter memory 540 included in the layer block 501 of the present disclosure.

In an embodiment of the present disclosure, the size of the first filter memory 540 may include an address and a bitwidth. In an embodiment, the first filter memory 540 may include N physically distinct sub memories 700 and 710.

In an embodiment, each of the N sub memories 700 and 710 may have an address having a size of A bytes. In an embodiment, each of the N sub memories 700 and 710 may have a bitwidth having a size of M bits. However, a unit of address of each of the sub memories 700 and 710 is not limited to bytes, and a unit of bitwidth is not limited to bits. In this case, A, N, and M may each be a natural number.

In an embodiment, the first filter memory 540 may store a convolution filter used in one layer block 501. In an embodiment, the first filter memory 540 may store a convolution filter used in one layer block 501 in the current frame.

In an embodiment, when two or more sub convolution filters are used in one layer block 501, two or more sub convolution filters may be stored in the first filter memory 540. In an embodiment, when N sub convolution filters are used in one layer block 501, the sub convolution filters may be stored in each of the N sub memories 700 and 710. In this case, the fact that the convolution filter is stored in the first filter memory 540 may mean that coefficients included in the convolution filter are stored in the first filter memory 540. The fact that the sub convolution filter is stored in each of the N sub memories 700 and 710 may mean that the coefficients included in the sub convolution filter are stored in each of the N sub memories 700 and 710.

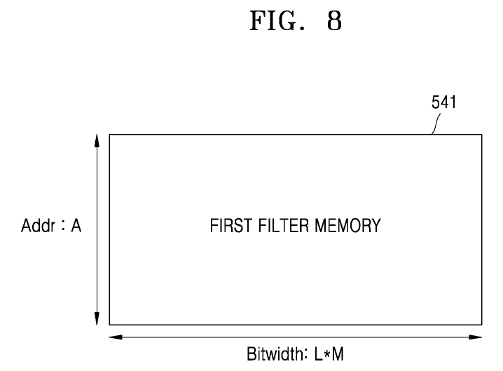

FIG. 8 is a diagram for explaining the configuration of a first filter memory according to an embodiment of the present disclosure. Hereinafter, the same components as those described with reference to FIG. 7 are denoted by the same reference numerals and repeated descriptions are omitted.

Referring to FIGS. 5 and 8, in an embodiment, FIG. 8 illustrates the configuration of a first filter memory 541 included in the layer block 501 of the present disclosure.

In an embodiment of the present disclosure, the first filter memory 541 may have an address having a size of A bytes. The first filter memory 541 may have a bitwidth having a size of L*M bits. In this case, L may be a natural number greater than or equal to 2. In an embodiment, the layer block 501 may include the first filter memory 541 having an address with a size of A bytes and a bitwidth with a size of L*M bits.

In an embodiment, the first filter memory 541 may store a convolution filter used in one layer block 501 in the current frame. In an embodiment, when two or more sub convolution filters are used in one layer block 501, two or more sub convolution filters may be stored in the first filter memory 541. In an embodiment, when L sub convolution filters are used in one layer block 501, the L sub convolution filters may be stored in the first filter memory 541 having an address having a size of A bytes and a bitwidth having a size of L*M bits.

In this case, the fact that the L convolution filters are stored in the first filter memory 541 may mean that a plurality of coefficients included in the L convolution filters are stored in the first filter memory 541.

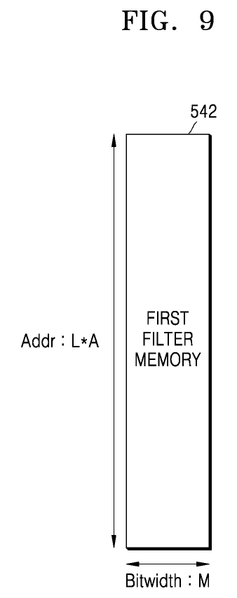

FIG. 9 is a diagram for explaining the configuration of a first filter memory according to an embodiment of the present disclosure. Hereinafter, the same components as those described with reference to FIG. 7 are denoted by the same reference numerals and repeated descriptions are omitted.

Referring to FIGS. 5 and 9, in an embodiment, FIG. 9 illustrates the configuration of a first filter memory 542 included in the layer block 501 of the present disclosure.

In an embodiment of the present disclosure, the first filter memory 542 may have an address having a size of L*A bytes. The first filter memory 542 may have a bitwidth having a size of M bits. In this case, L may be a natural number greater than or equal to 2. In an embodiment, the layer block 501 may include the first filter memory 542 having an address with a size of L*A bytes and a bitwidth with a size of M bits.

In an embodiment, the first filter memory 542 may store a convolution filter used in one layer block 501 in the current frame. In an embodiment, when two or more sub convolution filters are used in one layer block 501, two or more sub convolution filters may be stored in the first filter memory 542. In an embodiment, when L sub convolution filters are used in one layer block 501, the L sub convolution filters may be stored in the first filter memory 542 having an address having a size of L*A bytes and a bitwidth having a size of M bits.

In this case, the fact that the L convolution filters are stored in the first filter memory 542 may mean that a plurality of coefficients included in the L convolution filters are stored in the first filter memory 542.

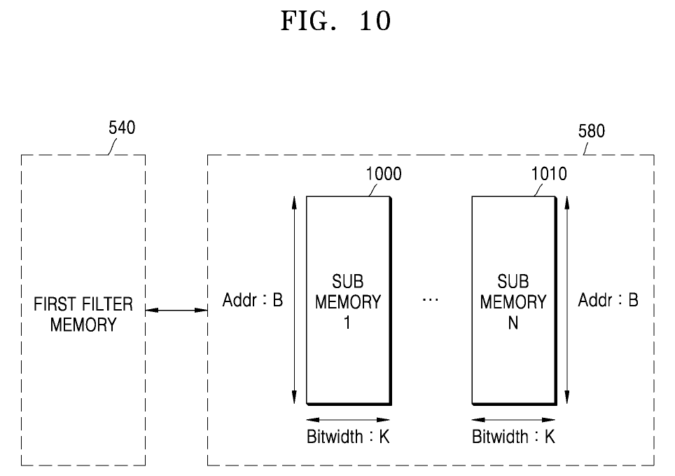

FIG. 10 is a diagram for explaining the configuration of a first filter memory according to an embodiment of the present disclosure.

Referring to FIGS. 5 and 10, in an embodiment, FIG. 10 illustrates the configuration of the first filter memory 540 and the second filter memory 580 included in the convolution block 500 of the present disclosure. In an embodiment, the first filter memory 540 illustrated in FIG. 10 may be illustrated as one of a plurality of first filter memories respectively included in a plurality of layer blocks.

In an embodiment of the present disclosure, the size of the second filter memory 580 may include an address and a bitwidth. In an embodiment, the second filter memory 580 may include N physically distinct sub memories 1000 and 1010.

In an embodiment, each of the N sub memories 1000 and 1010 may have an address having a size of B bytes. In an embodiment, each of the N sub memories 1000 and 1010 may have a bitwidth having a size of K bits. However, a unit of address of each of the sub memories 700 and 710 is not limited to bytes, and a unit of bitwidth is not limited to bits. In this case, B, N, and K may each be a natural number. The number of sub memories included in the first filter memory 540 illustrated in FIG. 7 and the number of sub memories included in the second filter memory 580 illustrated in FIG. 10 may be different from each other.

In an embodiment, the second filter memory 580 may store a plurality of convolution filters used in a plurality of layer blocks in one frame. In an embodiment, the second filter memory 580 may store a plurality of convolution filters used in a plurality of layer blocks in a next frame. In this case, the fact that the plurality of convolution filters used in the plurality of layer blocks in one frame are stored in the second filter memory 580 may mean that a plurality of coefficients included in each of the plurality of convolution filters are stored in the second filter memory 580.

In an embodiment, the feed weight block 530 may read a plurality of convolution filters from the second filter memory 580 and store the plurality of convolution filters in the first filter memory 540 included in each of the plurality of layer blocks.

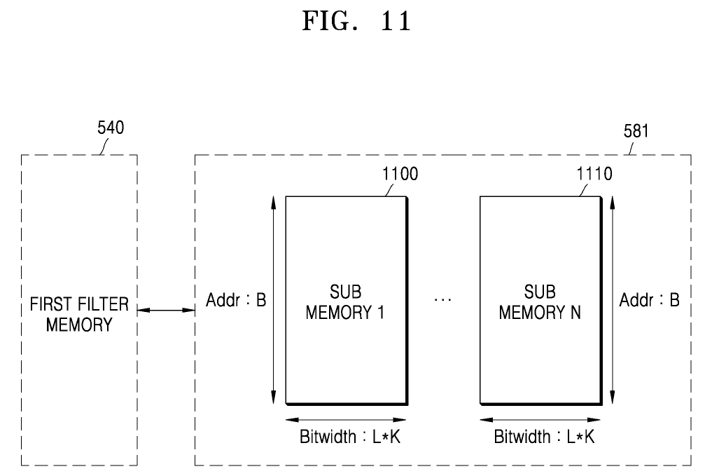

FIG. 11 is a diagram for explaining the configuration of a second filter memory according to an embodiment of the present disclosure. Hereinafter, repeated descriptions of the same components as those described with reference to FIG. 10 are omitted.

Referring to FIGS. 5 and 11, in an embodiment, FIG. 11 illustrates the configuration of the first filter memory 540 and the second filter memory 581 included in the convolution block 500 of the present disclosure.

In an embodiment of the present disclosure, the second filter memory 581 may include N physically distinct sub memories 1100 and 1110. Each of the N sub memories 1100 and 1110 may have an address with a size of B bytes. Each of the N sub memories 1100 and 1110 may have a bitwidth with a size of L*K bits. In this case, L may be a natural number greater than or equal to 2.

In an embodiment, when two or more sub convolution filters are used in each of a plurality of layer blocks, two or more sub convolution filters used in each layer block may be stored in each of the N sub memories 1100 and 1110 included in the second filter memory 581. In an embodiment, when L sub convolution filters are used in each layer block, the L sub convolution filters may be stored in each of the N sub memories 1100 and 1110 included in the second filter memory 581.

In this case, the fact that the L sub convolution filters are stored in each of the N sub memories 1100 and 1110 included in the second filter memory 581 may mean that a plurality of coefficients included in the L sub convolution filters are stored in each of the N sub memories 1100 and 1110 included in the second filter memory 581.

FIG. 12 is a diagram for explaining the configuration of memory according to an embodiment of the present disclosure. Hereinafter, repeated descriptions of the same components as those described with reference to FIG. 10 are omitted.

Referring to FIGS. 5 and 12, in an embodiment, FIG. 12 illustrates the configuration of the first filter memory 540 and a second filter memory 582 included in the convolution block 500 of the present disclosure.

In an embodiment of the present disclosure, the second filter memory 582 may include N physically distinct sub memories 1200 and 1210. Each of the N sub memories 1200 and 1210 may have an address with a size of L*B bytes. Each of the N sub memories 1200 and 1210 may have a bitwidth with a size of K bits. In this case, L may be a natural number greater than or equal to 2.

In an embodiment, when two or more sub convolution filters are used in each of a plurality of layer blocks, two or more sub convolution filters used in each layer block may be stored in each of the N sub memories 1100 and 1110 included in the second filter memory 582.

FIG. 13 is a diagram for explaining the configuration of a first filter memory according to an embodiment of the present disclosure. Hereinafter, repeated descriptions of the same components as those described with reference to FIG. 10 are omitted.

Referring to FIGS. 5 and 13, in an embodiment, FIG. 13 illustrates the configuration of the first filter memory 540 and a second filter memory 583 included in the convolution block 500 of the present disclosure.

In an embodiment of the present disclosure, the second filter memory 583 may include N physically distinct sub memories 1300 and 1310. Each of the N sub memories 1300 and 1310 may be logically divided into J memories. Each of the logically separated memories within each of the sub memories 1300 and 1310 may have an address having a size of B bytes. Each of the logically separated memories within each of the sub memories 1300 and 1310 may have a bitwidth having a size of K bits. In this case, B, J, K, and N may each be a natural number greater than or equal to 2.

In an embodiment, when two or more sub convolution filters are used in each of a plurality of layer blocks, two or more sub convolution filters used in each layer block may be stored in each of the N sub memories 1300 and 1310 included in the second filter memory 583. In an embodiment, when L sub convolution filters are used in each layer block, the L sub convolution filters may be stored in each of the N sub memories 1300 and 1310 logically divided into J, which are included in the second filter memory 583.

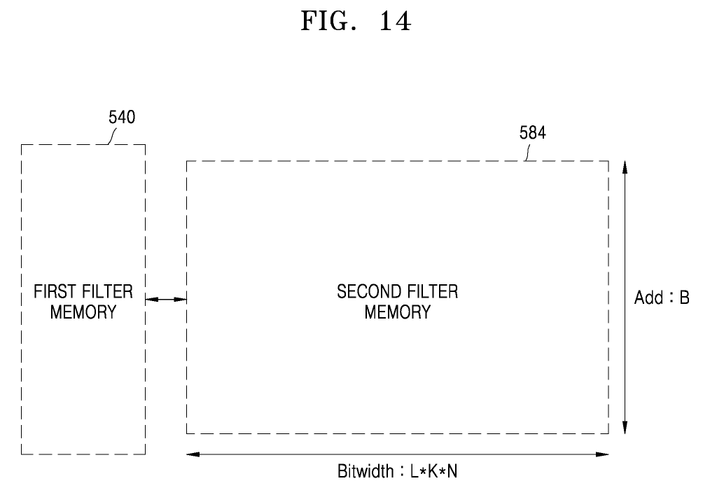

FIG. 14 is a diagram for explaining the configuration of a second filter memory according to an embodiment of the present disclosure. Hereinafter, repeated descriptions of the same components as those described with reference to FIG. 10 are omitted.

Referring to FIGS. 5 and 14, in an embodiment, FIG. 14 illustrates the configuration of the first filter memory 540 and a second filter memory 584 included in the convolution block 500 of the present disclosure.

In an embodiment of the present disclosure, the second filter memory 584 may have an address having a size of B bytes. The second filter memory 584 may have a bitwidth having a size of L*K*N bits. In this case, B, K, N, and L may each be a natural number greater than or equal to 2. In an embodiment, the convolution block 500 may include the second filter memory 584 having an address with a size of B bytes and a bitwidth with a size of L*K*N bits.

In an embodiment, the second filter memory 584 may store a plurality of convolution filters used in a plurality of layer blocks in one frame. In an embodiment, when two or more sub convolution filters are used in each of a plurality of layer blocks, two or more sub convolution filters used in each layer block may be stored in the second filter memory 584. In an embodiment, when the convolution block 500 includes N layer blocks and L sub convolution filters are used in each of the N layer blocks, N*L sub convolution filters may be stored in the second filter memory 584.

In this case, the fact that N*L convolution filters are stored in a second filter memory 584 may mean that a plurality of coefficients included in the N*L convolution filters are stored in the second filter memory 584. However, the present disclosure is not limited thereto, and the configuration of the data memory 520, the first filter memory 540, and the second filter memory 584 may vary depending on the number of convolution filters, the size of each of the convolution filters, the manufacturing cost, the free space within the electronic device 100, and the like.

FIG. 15 is a diagram for explaining an operation of performing a convolution operation by using a first weight map and a plurality of convolution filters according to an embodiment of the present disclosure.

Referring to FIGS. 1, 2, 3, 4, and 15, in an embodiment, the at least one processor 150 may divide the input image 110 into a plurality of areas 1510, 1520, and 1530. In an embodiment, when a pretrained convolution neural network 200 is trained to perform a convolution operation by using a plurality of sub convolution filters in one frame, the at least one processor 150 may divide the input image 110 into the plurality of areas 1510, 1520, and 1530 on which a convolution operation is to be performed using each of the plurality of sub convolution filters.

In an embodiment, when the plurality of sub convolution filters include a first sub convolution filter and a second sub convolution filter, the at least one processor 150 may divide the input image 110 into a first area 1510 on which a convolution operation is to be performed using the first sub convolution filter, a second area 1520 on which a convolution operation is to be performed using the second sub convolution filter, and a third area 1530 on which a convolution operation is to be performed using the first sub convolution filter and the second sub convolution filter.

In an embodiment, the at least one processor 150 may analyze the input image 110 to generate a first weight map 1500 including weights of the first sub convolution filter and the second sub convolution filter, respectively, in the first area 1510, the second area 1520, and the third area 1530.

In an embodiment, each of the first sub convolution filter and the second sub convolution filter may have different coefficients. In an embodiment, the first sub convolution filter may be a filter having an appropriate coefficient when performing a convolution operation to increase the resolution of a background of an image. The second sub convolution filter may be a filter having an appropriate coefficient when performing a convolution operation to increase the resolution of an object of an image. However, the present disclosure is not limited thereto, and the first sub convolution filter and the second sub convolution filter may be appropriate filters when performing a convolution operation for high-resolution conversion for areas having different characteristics.

In an embodiment, the third area 1530 may be an area that distinguishes the background and object included in the image. In the third area 1530, a convolution operation may be performed based on a combination of coefficients included in the first sub convolution filter and coefficients included in the second sub convolution filter.

In an embodiment, when the first sub convolution filter is referred to as model 1 and the second sub convolution filter is referred to as model 2, the at least one processor 150 may define ‘α*(model 1-model 2)+model 2’ as model 3, and generate the first weight map 1500 as a map having α as a weight for model 3 in each of a plurality of areas.

In an embodiment, the first weight map 1500 may have a weight value of ‘1’ in the first area 1510. The first weight map 1500 may have a weight value of ‘0’ in the second area 1520. The first weight map 1500 may have a weight value between ‘1’ and ‘0’ in the third area 1530.

By doing so, in addition to the first area 1510 and the second area 1520, it may be possible to obtain a convolution filter to be used in the first area 1510, the second area 1520, and the third area 1530 through one model 3 without having to perform a sum operation, difference operation, or multiplication operation to perform a convolution operation in the third area 1530 by using models 1 and 2.

FIG. 16 is a diagram for explaining an operation of generating a final output image by using an input image, an output image, and a second weight map according to an embodiment of the present disclosure.

Referring to FIGS. 1, 3, and 16, in an embodiment, the at least one processor 150 may generate the final output image 120 based on an input image 1600 and an output image 1610 generated through the convolution neural network 200. In an embodiment, the output image 1610 may be a result obtained by performing a convolution operation by using a plurality of convolution filters to convert the resolution of the input image 1600 to a high resolution.

In an embodiment, the at least one processor 150 may generate a final output image through postprocessing, such as a sum operation, of the input image 1600 and the output image 1610.

However, in an embodiment of the present disclosure, the at least one processor 150 may generate a final output image through postprocessing, such as generating a second weight map 1620, performing a multiplication operation on the generated second weight map 1620 and the output image 1610, and then performing a sum operation of adding the result to the input image 1600.

In an embodiment, the second weight map 1620 may be a map including weights 1621, 1622, and 1623 respectively corresponding to a plurality of output areas 1611, 1612, and 1613 included in the output image 1610 to be integrated into the input image 1600, based on the input image 1600. In an embodiment, the at least one processor 150 may generate the second weight map 1620 by analyzing the input image 1600 to determine an extent to which a result value generated through the convolution neural network 200 is integrated into the input image 1600. In this case, the at least one processor 150 may generate the second weight map 1620 based on the type of object included in the input image 1600, the size of the object, the color of the object, the contrast between the object and the background, sharpness, contrast ratio, and the like.

In an embodiment, the at least one processor 150 may generate the second weight map 1620 based on user input obtained through a user interface. The user input may include information about the user input that determines an extent to which the resolution of a certain area of the input image 1600 is increased or decreased.

In an embodiment, as the weight included in the second weight map 1620 increases, the extent to which the output image 1610 is integrated into the input image 1600 may also increase. By doing so, the extent to which the resolution of the image is increased may be varied based on the input image 1600. User satisfaction may be enhanced by providing users with a selectable option for resolution upscaling.

To resolve the technical object described above, in an embodiment of the present disclosure, an electronic device for performing a convolution operation is provided. The electronic device may include memory storing at least one instruction. The electronic device may include a first filter memory that stores a first convolution filter used in a convolution operation in the current frame. The electronic device may include a second filter memory that stores a second convolution filter used in a convolution operation in a next frame. The electronic device may include at least one processor. The at least one processor may execute at least one instruction to cause the electronic device to obtain a first convolution filter from a first filter memory in the current frame and perform a convolution operation by using the obtained first convolution filter on an input image. The at least one processor may execute at least one instruction to cause the electronic device to obtain a second convolution filter from a second filter memory in a next frame and perform a convolution operation by using the obtained second convolution filter on the input image to obtain an output image.

In an embodiment of the present disclosure, each of the first convolution filter and the second convolution filter may include a plurality of sub convolution filters. The at least one processor may execute at least one instruction to cause the electronic device to divide the input image into a plurality of areas on which a convolution operation is to be performed using different sub convolution filters based on the input image. The at least one processor may execute at least one instruction to cause the electronic device to perform a convolution operation on the input image in one frame by using a plurality of sub convolution filters based on the divided plurality of areas.

In an embodiment of the present disclosure, at least one processor may execute at least one instruction to cause the electronic device to generate a first weight map including respective weights of the plurality of sub convolution filters to be respectively used for the plurality of areas when performing a convolution operation based on the input image. The at least one processor may execute at least one instruction to cause the electronic device to perform a convolution operation on the input image in one frame by using a plurality of sub convolution filters based on the generated first weight map.

In an embodiment of the present disclosure, the plurality of sub convolution filters may include the first sub convolution filter and the second sub convolution filter. The at least one processor may execute at least one instruction to cause the electronic device to divide the input image into a first area in which a convolution operation is to be performed using the first sub convolution filter, a second area on which a convolution operation is to be performed using the second sub convolution filter, and a third area on which a convolution operation is to be performed using a convolution filter based on the first sub convolution filter and the second sub convolution filter.

In an embodiment of the present disclosure, the obtained output image may be an image for converting the resolution of the input image to a high resolution. The at least one processor may execute at least one instruction to cause the electronic device to convert the resolution of the input image to a high resolution based on the input image and the output image to generate a final output image.

In an embodiment of the present disclosure, the at least one processor may execute at least one instruction to cause the electronic device to generate a second weight map including respective weights of a plurality of output areas included in an output image to be integrated into the input image based on the input image. The at least one processor may execute at least one instruction to cause the electronic device to generate the final output image by adding a result of multiplying the generated second weight map and the output image to the input image.

In an embodiment of the present disclosure, the electronic device may further include a user interface. The at least one processor may execute at least one instruction to cause the electronic device to obtain user input from a user through a user interface to determine an extent to which the resolution of the input image is converted to a high resolution. The at least one processor may execute at least one instruction to cause the electronic device to generate a second weight map based on the image input and the obtained user input. The respective weights of the plurality of output areas included in the second weight map may vary according to the user input.

In an embodiment of the present disclosure, one frame may include a first section and a second section that are distinct from each other. The at least one processor may execute at least one instruction to cause the electronic device to perform a convolution operation by using the first convolution filter obtained for the input image in the second section to obtain an output image. The second section may be a section in which an input image is provided.

In an embodiment of the present disclosure, the at least one processor may execute at least one instruction to cause the electronic device to obtain a second convolution filter from a second filter memory in the first section and store the second convolution filter in the first filter memory. The at least one processor may execute at least one instruction to cause the electronic device to obtain the output image by performing the convolution operation on the input image by using the second convolution filter stored in the first filter memory as the first convolution filter.

In an embodiment of the present disclosure, the electronic device may include a third filter memory that stores a plurality of convolution filters used in a convolution operation during a plurality of frames. The at least one processor may execute at least one instruction to cause the electronic device to obtain the second convolution filter among the plurality of convolution filters from a third filter memory in one frame. The at least one processor may execute at least one instruction to cause the electronic device to store the obtained second convolution filter in the second filter memory.

To resolve the technical object described above, in an embodiment of the present disclosure, an operating method of the electronic device for performing a convolution operation is provided. The operating method of the electronic device may include obtaining a first convolution filter used for a convolution operation in a current frame from a first filter memory. The operating method of the electronic device may include performing a convolution operation by using the obtained first convolution filter on an input image in the current frame. The operating method of the electronic device may include obtaining a second convolution filter used for a convolution operation in a next frame from a second filter memory. The operating method of the electronic device may include performing a convolution operation on an input image by using the obtained second convolution filter in the next frame to obtain an output image.

In an embodiment of the present disclosure, each of the first convolution filter and the second convolution filter may include a plurality of sub convolution filters. The operating method of the electronic device may include analyzing the input image and dividing the input image into a plurality of areas on which a convolution operation is to be performed using different sub convolution filters. In each of the performing of the convolution operation in the current frame and the performing of the convolution operation in the next frame, a convolution operation may be performed on the input image in one frame by using a plurality of sub convolution filters based on the divided plurality of areas.

In an embodiment of the present disclosure, the dividing of the input image into a plurality of areas may include generating a first weight map including respective weights of a plurality of sub convolution filters to be respectively used for the plurality of areas when performing a convolution operation based on the input image. In each of the performing of the convolution operation in the current frame and the performing of the convolution operation in the next frame, a convolution operation may be performed on the input image in one frame by using the plurality of sub convolution filters based on the generated first weight map.

In an embodiment of the present disclosure, the plurality of sub convolution filters may include the first sub convolution filter and the second sub convolution filter. The dividing of the input image into a plurality of areas may include dividing the input image into a first area in which a convolution operation is to be performed using the first sub convolution filter, a second area on which a convolution operation is to be performed using the second sub convolution filter, and a third area on which a convolution operation is to be performed using a convolution filter based on the first sub convolution filter and the second sub convolution filter.

In an embodiment of the present disclosure, the obtained output image may be an image for converting the resolution of the input image to a high resolution. The operating method of the electronic device may include generating a final output image by converting the resolution of the input image to a high resolution based on the input image and the output image.

In an embodiment of the present disclosure, the operating method of the electronic device may include generating a second weight map including respective weights of a plurality of output areas included in the output image to be integrated into the input image, based on the input image. In the generating of the final output image, the result of multiplying the generated second weight map and the output image may be added to the input image to generate the final output image.

In an embodiment of the present disclosure, the operating method of the electronic device may include obtaining user input from a user through a user interface to determine an extent to which the resolution of the input image is converted to a high resolution. In the generating of the second weight map, the second weight map may be generated based on the input image and the obtained user input. The respective weights of a plurality of output areas included in the second weight map may vary depending on user input.

In an embodiment of the present disclosure, one frame may include a first section and a second section that are distinct from each other. The performing of the convolution operation by using the first convolution filter obtained for the input image may be performed in the second section. The second section may be a section in which an input image is provided.

In an embodiment of the present disclosure, the operating method of the electronic device may include, in one frame, obtaining a second convolution filter among a plurality of convolution filters from a third filter memory that stores a plurality of convolution filters used for a convolution operation during a plurality of frames, and storing the second convolution filter in a second filter memory. The operating method of the electronic device may include obtaining the second convolution filter from the second filter memory in a first section and storing the second convolution filter in the first filter memory. In the performing of the convolution operation on the input image in the second section, the convolution operation may be performed on the input image by using the second convolution filter stored in the first filter memory as the first convolution filter to obtain the output image.

To resolve the technical object described above, a computer-readable recording medium having recorded thereon a program for performing at least one method of the operating method of the electronic device disclosed in an embodiment may be provided.

The program executed by the electronic device described in the present disclosure may be implemented as a hardware component, a software component, and/or a combination of hardware components and software components. The program may be executed by any system capable of executing computer-readable instructions.

Software may include a computer program, code, instructions, or a combination of one or more of these, which may configure a processing device to operate as desired or may independently or collectively command the processing device to operate as desired.

Software may be implemented as a computer program including instructions stored on a computer-readable storage medium. Examples of the computer-readable recording medium include a magnetic storage medium (e.g., read-only memory (ROM), random-access memory (RAM), floppy disk, or hard disk) and an optical readable medium (e.g., CD-ROM or digital versatile disc (DVD)). The computer-readable recording medium may be distributed across network-connected computer systems, allowing computer-readable code to be stored and executed in a distributed manner. The recording medium may be read by a computer, stored in memory, and executed by a processor.

The computer-readable storage medium may be provided in the form of a non-transitory storage medium. Here, the term ‘non-transitory storage medium’ simply means a tangible device that does not contain a signal (e.g. electromagnetic wave), and the term does not distinguish between cases in which data is stored semi-permanently or temporarily in a storage medium. For example, the ‘non-transitory storage medium’ may include a buffer in which data is temporarily stored.

A program according to embodiments of the present disclosure may be provided as included in a computer program product. The computer program product may be traded between a seller and a buyer as commodities.

The computer program product may include a software program, and a computer-readable storage medium having the software program stored thereon. For example, the computer program product may include a product in the form of a software program (e.g., a downloadable application) that is distributed electronically by a manufacturer of an electronic device or through an electronic marketplace (e.g., Samsung Galaxy Store). For electronic distribution, at least a portion of the software program may be stored on a storage medium or temporarily generated. In this case, the storage medium may be a server of an electronic device manufacturer, a server of an electronic market, or a storage medium of a relay server that temporarily stores software programs.

Although the embodiments have been described by way of limited examples and drawings, those of skill in the art will appreciate that various modifications and variations may be made from the above description. For example, suitable results may be obtained even when the described technologies are performed in a different order than described, and/or components of the described computer system or modules are combined or combined in a different manner than described, or are replaced or substituted by other components or equivalents.

What is claimed is:

1. An electronic device for performing a convolution operation, the electronic device comprising:
memory storing at least one instruction;
a first filter memory storing a first convolution filter used in the convolution operation in a current frame;
a second filter memory storing a second convolution filter used in the convolution operation in a next frame; and
at least one processor, comprising processing circuitry,
wherein the least one instruction, when executed by the at least one processor individually or collectively, causes the electronic device to:
in the current frame, obtain the first convolution filter from the first filter memory and perform the convolution operation on an input image by using the first convolution filter, and
in the next frame, obtain the second convolution filter from the second filter memory and perform the convolution operation on the input image by using the second convolution filter to obtain an output image.

2. The electronic device of claim 1, wherein each of the first convolution filter and the second convolution filter comprises a plurality of sub convolution filters, and
wherein the least one instruction, when executed by the at least one processor individually or collectively, causes the electronic device to:
based on the input image, divide the input image into a plurality of areas in which the convolution operation is to be performed using different sub convolution filters, and
based on the divided plurality of areas, perform the convolution operation on the input image in one frame by using the plurality of sub convolution filters.

3. The electronic device of claim 2, wherein the least one instruction, when executed by the at least one processor individually or collectively, causes the electronic device to:
when performing the convolution operation based on the input image, generate a first weight map comprising respective weights of the plurality of sub convolution filters to be respectively used for the plurality of areas, and
based on the first weight map, perform the convolution operation on the input image in the one frame by using the plurality of sub convolution filters.

4. The electronic device of claim 2, wherein the plurality of sub convolution filters comprise a first sub convolution filter and a second sub convolution filter, and
wherein the least one instruction, when executed by the at least one processor individually or collectively, causes the electronic device to divide the input image into a first area in which the convolution operation is to be performed using the first sub convolution filter, a second area in which the convolution operation is to be performed using the second sub convolution filter, and a third area in which the convolution operation is to be performed using a convolution filter based on the first sub convolution filter and the second sub convolution filter.

5. The electronic device of claim 1, wherein the output image is an image for converting resolution of the input image to a high resolution, and
wherein the least one instruction, when executed by the at least one processor individually or collectively, causes the electronic device to generate a final output image by converting the resolution of the input image to the high resolution based on the input image and the output image.

6. The electronic device of claim 5, wherein the least one instruction, when executed by the at least one processor individually or collectively, causes the electronic device to, based on the input image, generate a second weight map comprising respective weights of a plurality of output areas in the output image to be integrated into the input image, and generate the final output image by adding a result of multiplying the second weight map and the output image to the input image.

7. The electronic device of claim 6, wherein the electronic device further comprises a user interface,
wherein the least one instruction, when executed by the at least one processor individually or collectively, causes the electronic device to:
obtain a user input from a user through the user interface to determine an extent to which the resolution of the input image is converted to the high resolution, and
generate the second weight map based on the input image and the user input, and
wherein the respective weights of the plurality of output areas in the second weight map vary according to the user input.

8. The electronic device of claim 1, wherein one frame comprises a first section and a second section, which are separate from each other,
wherein the least one instruction, when executed by the at least one processor individually or collectively, causes the electronic device to, in the second section, obtain the output image by performing the convolution operation on the input image by using the first convolution filter, and
wherein the second section is a section in which the input image is provided.

9. The electronic device of claim 8, wherein the least one instruction, when executed by the at least one processor individually or collectively, causes the electronic device to:
in the first section, obtain the second convolution filter from the second filter memory and store the second convolution filter in the first filter memory, and
obtain the output image by performing the convolution operation on the input image by using the second convolution filter stored in the first filter memory as the first convolution filter.

10. The electronic device of claim 8, wherein the electronic device comprises a third filter memory storing a plurality of convolution filters used in the convolution operation during a plurality of frames, and
wherein the least one instruction, when executed by the at least one processor individually or collectively, causes the electronic device to, in the one frame, obtain the second convolution filter among the plurality of convolution filters from the third filter memory, and store the second convolution filter in the second filter memory.

11. A method of an electronic device for performing a convolution operation, the method comprising:
obtaining a first convolution filter used for the convolution operation in a current frame from a first filter memory;
in the current frame, performing the convolution operation on an input image by using the first convolution filter;
obtaining a second convolution filter used for the convolution operation in a next frame from a second filter memory; and
in the next frame, performing the convolution operation on the input image by using the second convolution filter to obtain an output image.

12. The method of claim 11, wherein each of the first convolution filter and the second convolution filter comprises a plurality of sub convolution filters,
wherein the method further comprises analyzing the input image and dividing the input image into a plurality of areas in which the convolution operation is to be performed using different sub convolution filters, and
wherein, in each of the performing of the convolution operation in the current frame and the performing of the convolution operation in the next frame, based on the divided plurality of areas, the convolution operation is performed on the input image in one frame by using the plurality of sub convolution filters.

13. The method of claim 12, wherein the dividing of the input image into the plurality of areas comprises:
when performing the convolution operation based on the input image, generating a first weight map comprising respective weights of the plurality of sub convolution filters to be respectively used for the plurality of areas; and
in each of the performing of the convolution operation in the current frame and the performing of the convolution operation in the next frame, and
wherein, based on the first weight map, the convolution operation is performed on the input image in the one frame by using the plurality of sub convolution filters.

14. The method of claim 12, wherein the plurality of sub convolution filters comprises a first sub convolution filter and a second sub convolution filter, and
wherein, in the dividing of the input image into the plurality of areas, the input image is divided into a first area in which the convolution operation is to be performed using the first sub convolution filter, a second area in which the convolution operation is to be performed using the second sub convolution filter, and a third area in which the convolution operation is to be performed using a convolution filter based on the first sub convolution filter and the second sub convolution filter.

15. The method of claim 11, wherein the output image is an image for converting the resolution of the input image to a high resolution, and
wherein the method further comprises generating a final output image by converting the resolution of the input image to the high resolution based on the input image and the output image.

16. The method of claim 15, further comprising:
generating a second weight map comprising respective weights of a plurality of output areas in the output image to be integrated into the input image, based on the input image, and
wherein the generating the final output image comprises generating the final output image by adding a result of multiplying the second weight map and the output image to the input image.

17. The method of claim 16, further comprising:
obtaining a user input from a user through a user interface to determine an extent to which the resolution of the input image is converted to the high resolution,
wherein the generating the second weight map comprises generating the second weight map based on the input image and the user input, and
wherein the respective weights of the plurality of output areas in the second weight map vary depending on the user input.

18. The method of claim 11, wherein one frame comprises a first section and a second section that are separate from each other,
wherein the performing of the convolution operation by using the first convolution filter obtained for the input image is performed in the second section, and
wherein the second section is a section in which the input image is provided.

19. The method of claim 18, further comprising:
in the one frame, obtaining the second convolution filter among a plurality of convolution filters from a third filter memory that stores the plurality of convolution filters used for the convolution operation during a plurality of frames, and storing the second convolution filter in the second filter memory; and
in the first section, obtaining the second convolution filter from the second filter memory and storing the second convolution filter in the first filter memory,
wherein in the performing of the convolution operation on the input image in the second section, the convolution operation is performed on the input image by using the second convolution filter stored in the first filter memory as the first convolution filter to obtain the output image.

20. A non-transitory computer-readable medium having recorded thereon a program comprising instructions that are executed by at least one processor of an electronic device to perform a method of performing a convolution operation, the method comprising:
obtaining a first convolution filter used for the convolution operation in a current frame from a first filter memory;
in the current frame, performing the convolution operation on an input image by using the first convolution filter;
obtaining a second convolution filter used for the convolution operation in a next frame from a second filter memory; and
in the next frame, performing the convolution operation on the input image by using the second convolution filter to obtain an output image.
